(19) United States
(12) Patent Application Publication
(10) Pub. No.: US 2010/0204033 A1
(43) Pub. Date: Aug. 12, 2010

(54) ZIRCONIUM DIOXIDE POWDER AND ZIRCONIUM DIOXIDE DISPERSION

(75) Inventors: Stipan Katusic, Bad Soden (DE); Christoph Tontrup, Alzenau (DE); Martin Moerters, Rheinfelden (DE); Witold Katerinak, Wehr (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/678,616

(22) PCT Filed: Oct. 6, 2008
(86) PCT No.: PCT/EP2008/063327

§ 371 Date: Mar. 17, 2010

(30) Foreign Application Priority Data
Oct. 23, 2007 (EP) 07119044.1

(51) Int. Cl. C04B 35/48; C01G 25/02; C04B 35/03

(52) U.S. Cl. 501/135; 423/608; 501/134

(57) ABSTRACT

Zirconium dioxide powder in the form of aggregated primary particles, having a BET surface area of 30 to 150 m2/g and a Berger whiteness of at least 88%. It is prepared by atomizing a solution which comprises an organic zirconium compound and mixing it with a combustion gas and air and allowing the mixture to burn in a flame into a reaction chamber surrounded by a casing, where the temperature in the reaction chamber and along the side of the wall of the casing facing the reaction chamber is at least 500° C. Dispersion comprising the zirconium dioxide powder. Use of the zirconium dioxide powder and of the dispersion for producing ceramics.

The invention relates to a zirconium dioxide powder, to a process for its preparation and to its use. The invention further relates to a dispersion comprising this zirconium dioxide powder and to its use.

EP-A-717008 discloses a pyrogenic zirconium dioxide powder having a specific surface area between 20 and 200 m²/g, composed of primary particles of size 7 to 100 nm which may be combined with one another. The powder has a tamped density between 40 and 150 g/l, the Sears number is between 1 and 20 ml/2 g and the chlorine content is less than 0.6% by weight. A disadvantage of this powder is that chloride contents of less than 0.3% by weight can be achieved only through high-energy reaction conditions which again impair the appearance and the physical properties of the powder.

EP-A-1142830 discloses a nanoscale pyrogenic zirconium dioxide powder having a BET surface area between 1 and 600 m²/g and a total chloride content of less than 0.05% by weight. It is prepared by, for example, atomizing zirconium n-propoxide in n-propanol and combusting it in a hydrogen/oxygen gas flame. A disadvantage of this powder is that it is greyish.

DE-A-102004061698 discloses a zirconium dioxide powder in the form of aggregates of primary particles, which has a BET surface area of 60±15 m²/g, an average primary particle diameter of less than 20 nm, an average aggregate surface area of less than 10 000 nm², an average equivalent circle diameter of less than 100 nm, an average aggregate circumference of less than 700 nm. In addition, the content of zirconium dioxide is 95 to 99.9% by weight, that of hafnium dioxide 0.1 to 5% by weight, that of carbon 0 to 0.15% by weight and that of chloride 0 to 0.05% by weight. A disadvantage of this powder is that it is greyish.

DE-A-102004039139 discloses a nanoscale yttrium-zirconium mixed oxide powder in the form of aggregated primary particles, which has a BET surface area of 40 to 100 m²/g and a mean, number-related primary particle diameter of 3 to 30 nm. The content of yttrium is 5 to 15% by weight, that of monoclinic zirconium dioxide <1 to 10% by weight, and that of tetragonal zirconium dioxide 10 to 95% by weight, the content of monoclinic zirconium oxide after heating to 1300° C. for 2 hours being less than 1% by weight.

U.S. Pat. No. 6,030,914 discloses a zirconium dioxide powder consisting of primary particles, which has a BET surface area of 40 to 200 m²/g and a mean particle size of at most 0.1 μm, where the ratio of mean particle size determined by means of electron microscopy to the mean particle size calculated from the BET surface area is at least 0.9. The numerical value of at least 0.9 is intended to express that the primary particles are not sintered with one another. The process for preparing this powder is very time-consuming and sensitive to impurities.

The numerous processes which are known for the preparation of high-surface area zirconium dioxide powder do not solve the problem of providing products with high purity and low greyness. Even though a bulk analysis of these products generally provides acceptable values, the significance of these values is limited, since even a few dark-coloured particles are sufficient not to allow the powder to appear white overall. However, specifically the visual impression is crucial in many applications.

It was therefore an object of the present invention to provide a powder which does not have these disadvantages. It was a further object to provide a process for preparing this powder.

The invention provides a finely dispersible zirconium dioxide powder which
is present in the form of aggregated primary particles,
and has a BET surface area of 30 to 150 m²/g and
a Berger whiteness of 88% or more, preferably 90% or more.

The inventive zirconium dioxide powder is finely dispersible. This should be understood to mean that the zirconium dioxide powder is dispersible such that the mean aggregate diameter in a dispersion is less than 200 nm.

The Berger whiteness is determined with the aid of the Micro Color from Dr. Lange. The Berger whiteness is defined as BW═RY+3 (RZ—RX) where RX, RY, RZ are corresponding reflection factors using an X, Y, Z colour analysis filter. A comprehensive description is given, for example, in the brochure “Grundlagen der Farbmessung” [Basics of colour analysis] (Lange, application report No. 10d DOC042.00.00017 07/2004).

The inventive zirconium dioxide powder is preferably of pyrogenic nature. “Pyrogenic” is understood to mean the hydrolysis or the oxidation of zirconium compounds in the gas phase in a flame, generated by the reaction of a hydrogen-containing combustion gas and oxygen. Initially high-dispersity nonporous primary particles are formed, which combine to form aggregates later in the reaction, and these can combine further to form agglomerates. The surfaces of these particles may have acidic or basic sites.

The primary particles of the inventive powder may comprise at least one component which stabilizes the tetragonal phase or the cubic phase of zirconium dioxide, in the form of an oxide of yttrium, calcium, magnesium or aluminium, and particular preference may be given especially to a zirconium dioxide partly stabilized with 3 mol % of yttrium or to a zirconium dioxide fully stabilized with 8 mol % of yttrium.

The inventive zirconium dioxide powder may preferably have a BET surface area of 35 to 65 m²/g, more preferably one of >35 to <50 m²/g and most preferably one of 37 to 43 m²/g. Especially the inventive zirconium dioxide powder having a BET surface area of 37 to 43 m²/g has, in dispersions, a high sedimentation stability with simultaneously good processibility. Processibility should be understood to mean that, when the inventive zirconium dioxide powder is used, the viscosity of dispersions, even at high filling levels, is low compared to the prior art. The BET surface area is determined to DIN 66131.

The inventive zirconium dioxide powder is also notable for its high purity. The sum of the proportions of zirconium dioxide or zirconium dioxide and stabilizing component is preferably at least 98% by weight, more preferably at least 99% by weight. The proportion of zirconium dioxide shall also include the proportions of the fraction of hafnium compounds in the form of hafnium dioxide which always occurs with zirconium compounds. The proportion of hafnium dioxide is generally 1 to 4% by weight, based on ZrO₂.

Additionally preferred is an inventive zirconium dioxide which comprises the elements Cd, Ce, Fe, Na, Nb, P, Ti, Zn in proportions of <10 ppm and the elements Ba, Bi, Cr, K, Mn, Sb in proportions of <5 ppm, where the sum of the proportions of all of these elements is <100 ppm.

The inventive zirconium dioxide powder may also have a proportion of chloride of less than 0.05% by weight, generally 0 to <0.5% by weight, preferably 0.01 to 0.3% by weight, based on the powder.

The proportion of carbon in the inventive zirconium dioxide powder may be less than 0.2% by weight, generally 0.005 to <0.2% by weight, preferably 0.01 to 0.1% by weight, based on the powder. The high purity may be important, for example, in the production of ceramics, when the objective is to avoid low-melting phases.

The inventive zirconium dioxide powder may also be a surface-modified zirconium dioxide powder. This can be obtained by reacting surface-modifying reagents with active groups on the surface of the zirconium dioxide. For this purpose, it is possible with preference to use the following silanes, individually or as a mixture:

organosilanes (RO)₃Si (CₙH₂ₙ₊₁) and (RO)₃Si (CₙH₂ₙ₋₁) where R=alkyl, such as methyl, ethyl, n-propyl, i-propyl, butyl and n=1-20.

organosilanes R′ₓ(RO)_{y}Si (CₙH₂ₙ₊₁) and R′ₓ(RO)_{y}Si (CₙH₂ₙ₋₁) where R=alkyl, such as methyl, ethyl, n-propyl, i-propyl, butyl;

R′=alkyl, such as methyl, ethyl, n-propyl, i-propyl, butyl; R′=cycloalkyl; n=1-20; x+y=3, x=1, 2; y=1, 2.

haloorganosilanes X₃Si(CₙH₂ₙ₊₁) and X₃Si(CₙH₂ₙ₋₁) where X=Cl, Br; n=1-20.

haloorganosilanes X₂(R′)Si(CₙH₂ₙ₊₁) and X₂(R′)Si(CₙH₂ₙ₋₁) where X=Cl, Br, R′=alkyl, such as methyl, ethyl, n-propyl, i-propyl, butyl; R′=cycloalkyl; n=1-20

haloorganosilanes X(R′)₂Si(CₙH₂ₙ₊₁) and X(R′)₂Si(CₙH₂ₙ₋₁) where X=Cl, Br; R′=alkyl, such as methyl, ethyl, n-propyl, i-propyl, butyl; R′=cycloalkyl; n=1-20

organosilanes (RO)₃Si(CH₂)₃(CH₂)ₘ—R′ where R=alkyl, such as methyl, ethyl, propyl; m=0, 1-20; R′=methyl, aryl such as —C₆H₅, substituted phenyl radicals, C₄F₉, OCF₂—CHF—CF₃, C₆F₁₃, OCF₂CHF₂, NH₂, N₃, SCN, CH═CH₂, NH—CH₂—CH₂—NH₂, N—(CH₂—CH₂—NH₂)₂, OOC(CH₃)C═CH₂, OCH₂—CH(O)CH₂, NH—CO—N—CO—(CH₂)₅, NH—COO—CH₃, NH—COO—CH₂—CH₃, NH—(CH₂)₃Si(OR)₃, Sₓ—(CH₂)₃Si(OR)₃, SH, NR′R″R′″ where R′=alkyl, aryl, R″=H, alkyl, aryl; R′″=H, alkyl, aryl, benzyl, C₂H₄NR″″R′″″ where R″″═H, alkyl and R′″″=H, alkyl.

organosilanes (R″)ₓ(RO)_{y}Si(CH₂)ₘ—R′ where R″ =alkyl, x+y=3; cycloalkyl, x=1, 2, y=1, 2; m=0, 1 to 20; R′=methyl, aryl, such as C₆H₅, substituted phenyl radicals, C₄F₉, OCF₂—CHF—CF₃, C₆F₁₃, OCF₂CHF₂, NH₂, N₃, SCN, CH═CH₂, NH—CH₂—CH₂—NH₂, N—(CH₂—CH₂—NH₂)₂, OOC(CH₃)C═CH₂, OCH₂—CH(O)CH₂, NH—CO—N—CO—(CH₂)₅, NH—COO—CH₃, NH—COO—CH₂—CH₃, NH—(CH₂)₃Si(OR)₃, Sₓ—(CH₂)₃Si(OR)₃, SH, NR′R″R′″ where R′=alkyl, aryl, R″=H, alkyl, aryl; R′″=H, alkyl, aryl, benzyl, C₂H₄NR″″″R′″″ where R″″=H, alkyl and R′″″=H, alkyl.

haloorganosilanes X₃Si(CH₂)ₘ—R′ X═Cl, Br; m=0, 1-20; R′=methyl, aryl such as C₆H₅, substituted phenyl radicals, C₄F₉, OCF₂—CHF—CF₃, C₆F₁₃, O—CF₂—CHF₂, NH₂, N₃, SCN, CH═CH₂, NH—CH₂—CH₂—NH₂, N—(CH₂—CH₂—NH₂)₂, —OOC(CH₃)C═CH₂, OCH₂—CH(O)CH₂, NH—CO—N—CO—(CH₂)₅, NH—COO—CH₃, —NH—COO—CH₂—CH₃, —NH—(CH₂)₃Si(OR)₃, —Sₓ—(CH₂)₃Si(OR)₃, where R=methyl, ethyl, propyl, butyl and x=1 or 2, SH.

haloorganosilanes RX₂Si(CH₂)ₘR′ X═Cl, Br; m=0, 1-20; R′=methyl, aryl such as C₆H₅, substituted phenyl radicals, C₄F₉, OCF₂—CHF—CF₃, C₆F₁₃, O—CF₂—CHF₂, NH₂, N₃, SCN, CH═CH₂, NH—CH₂—CH₂—NH₂, N—(CH₂—CH₂—NH₂)₂, —OOC(CH₃)C═CH₂, OCH₂—CH(O)CH₂, NH—CO—N—CO—(CH₂)₅, NH—COO—CH₃, —NH—COO—CH₂—CH₃, —NH—(CH₂)₃Si(OR)₃, —Sₓ—(CH₂)₃Si(OR)₃, where R=methyl, ethyl, propyl, butyl and x=1 or 2, SH.

haloorganosilanes R₂XSi(CH₂)ₘR′ X═Cl, Br; m=0, 1-20; R′=methyl, aryl such as C₆H₅, substituted phenyl radicals, C₄F₉, OCF₂—CHF—CF₃, C₆F₁₃, O—CF₂—CHF₂, NH₂, N₃, SCN, CH═CH₂, NH—CH₂—CH₂—NH₂, N—(CH₂—CH₂—NH₂)₂, —OOC(CH₃)C═CH₂, OCH₂—CH(O)CH₂, NH—CO—N—CO—(CH₂)₅, NH—COO—CH₃, —NH—COO—CH₂—CH₃, —NH—(CH₂)₃Si(OR), —Sₓ—(CH₂)₃Si(OR)₃, where R=methyl, ethyl, propyl, butyl and x=1 or 2, SH.

silazanes R′R₂SiNHSiR₂R′ where R, R′=alkyl, vinyl, aryl.

cyclic polysiloxanes D3, D4, D5 where D3, D4 and D5 are understood to mean cyclic poly-siloxanes having 3, 4 or 5 units of the —O—Si(CH₃)₂ type, for example octamethylcyclotetrasiloxane=D4

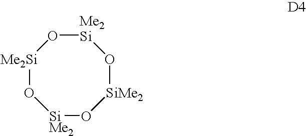

polysiloxanes or silicone oils of the type

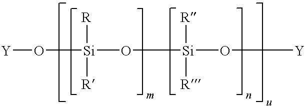

where

R=alkyl, aryl, (CH₂)ₙ—NH₂, H

R′=alkyl, aryl, (CH₂)ₙ—NH₂, H

R″=alkyl, aryl, (CH₂)ₙ—NH₂, H

R′″=alkyl, aryl, (CH₂)ₙ—NH₂, H

Y═CH₃, H, C₂H_{2z-1} where z=1-20, Si(CH₃)_{3,} Si(CH₃)₂H, Si(CH₃)₂OH, Si(CH₃)₂(OCH₃), Si(CH₃)₂(C₂H_{2z+1})

where

R′ or R″ or R′″ is (CH₂)_{z}—NH₂ and

z=1-20,

m=0, 1, 2, 3, . . . ∞,

n=0, 1, 2, 3, . . . ∞,

u=0, 1, 2, 3, . . . ∞,

The surface modifiers used may preferably be the following substances: octyltrimethoxysilane, octyltriethoxysilane, hexamethyldisilazane, 3-methacryloyloxypropyltrimethoxysilane, 3-methacryloyloxypropyltriethoxysilane, hexadecyltrimethoxysilane, hexadecyltriethoxysilane, dimethylpolysiloxane, glycidyloxypropyltrimethoxysilane, glycidyloxypropyltriethoxysilane, nonafluorohexyltrimethoxysilane, tridecafluorooctyltrimethoxysilane, tridecafluorooctyltriethoxysilane, aminopropyltriethoxysilane.

Particular preference may be given to using octyltrimethoxysilane, octyltriethoxysilane and dimethylpolysiloxanes.

The invention further provides a process for preparing the inventive zirconium dioxide powder, in which
a solution which, as a starting material for the zirconium dioxide, comprises at least one organic zirconium compound and optionally at least one compound which bears the stabilizing component is atomized, preferably by means of air or an inert gas, preferably using a multi-substance nozzle, and
mixed with a combustion gas, preferably hydrogen and/or methane, and air and
the mixture is allowed to burn in a flame into a reaction chamber surrounded by a casing,
the hot gases and the solid products are cooled and then the solid product is removed from the gases, where
the temperature in the reaction chamber and along the side of the wall of the casing facing the reaction chamber is at least 500° C.

In the process according to the invention, the temperature in the reaction chamber and at the wall of the casing may be the same. The casing may preferably be a high-temperature-resistant high-performance material, preferably based on a nickel alloy. In general, the temperatures will, however, be different. The temperature at the wall of the casing may preferably be 700 to 1100° C. If necessary, the wall of the casing can be heated.

As an alternative measure for heating the wall or as an additional measure, it has been found to be useful to conduct the process such that the temperature of the wall is initially kept at temperatures of less than 500° C. This leads to the side of the wall facing the reaction chamber being covered partly or completely with a firmly adhering layer of the solid products formed during the reaction. Subsequently, the temperature is then raised again to values of more than 500° C.

The starting material for the zirconium dioxide is, in the process according to the invention, of organic nature. It has been found to be advantageous when the starting material used is at least one zirconium carboxylate or exclusively zirconium carboxylates. Particular preference may be given to using zirconium carboxylates of aliphatic carboxylic acids having 6 to 9 carbon atoms, for example the comparatively readily available zirconium 2-ethylhexanoate.

If a zirconium dioxide powder is to be prepared in stabilized form, it is possible to use either inorganic or organic compounds. Examples include yttrium nitrate and yttrium 2-ethylhexanoate.

Preference is given to an embodiment of the process in which the starting materials are atomized dissolved in an organic solvent. Suitable solvents include methanol, ethanol, n-propanol, isopropanol, n-butanol, tert-butanol, 2-propanone, 2-butanone, diethyl ether, tert-butyl methyl ether, tetrahydrofuran, C₁-C₈-carboxylic acids, ethyl acetate, toluene, petroleum and mixtures thereof.

It has been found to be particularly advantageous when the solvent comprises one or more aliphatic carboxylic acids having 6 to 9 carbon atoms, especially 2-ethyl-hexanoic acid.

The zirconium concentration, calculated as ZrO₂, in the solution is preferably at least 15% by weight and not more than 35% by weight, based on the solution.

The invention further provides a dispersion comprising the inventive zirconium dioxide powder and having a content of zirconium dioxide of 20 to 70% by weight, preferably 30 to 60% by weight, and a mean aggregate diameter determined by means of laser diffraction of less than 200 nm, preferably less than 100 nm.

The liquid phase of the dispersion may be organic or aqueous. Aqueous is understood to mean that at least 80% by weight, preferably at least 90% by weight, more preferably at least 95% by weight, of the liquid phase consists of water.

The dispersion may further comprise a surface-modified zirconium dioxide powder which is obtainable by adding a surface modifier to a liquid phase comprising the inventive zirconium dioxide powder.

In the context of the invention, surface-modified is understood to mean that at least some of the hydroxyl groups present on the surface of the powder have reacted with a surface modifier to form a chemical bond. The chemical bond is preferably a covalent, ionic or coordinate bond between the surface modifier and the particle, but also hydrogen bonds. A coordinate bond is understood to mean complex formation. For instance, complex formation or an esterification can take place between the functional groups of the modifier and the particle, for example a Bronsted or Lewis acid/base reaction.

The functional groups which comprise the modifier are preferably carboxylic acid groups, acid chloride groups, ester groups, nitrile and isonitrile groups, OH groups, SH groups, epoxide groups, anhydride groups, acid amide groups, primary, secondary and tertiary amino groups, Si—OH groups, hydrolysable radicals of silanes or C—H-acidic moieties, as in beta-dicarbonyl compounds. The surface modifier may also comprise more than one such functional group, as for example in betaines, amino acids, EDTA.

Suitable surface modifiers may be:

saturated or unsaturated mono- and polycarboxylic acids having 1 to 24 carbon atoms, for example formic acid, acetic acid, propionic acid, butyric acid, pentanoic acid, hexanoic acid, acrylic acid, methacrylic acid, crotonic acid, citric acid, adipic acid, succinic acid, glutaric acid, oxalic acid, maleic acid, fumaric acid, itaconic acid and stearic acid, and the corresponding acid anhydrides, chlorides, esters and amides and salts thereof, especially the ammonium salts thereof. Also suitable are those carboxylic acids whose carbon chain is interrupted by O, S or NH groups, such as ether-carboxylic acids (mono- and polyethercarboxylic acids and the corresponding acid anhydrides, chlorides, esters and amides), oxacarboxylic acids such as 3,6-dioxaheptanoic acid and 2-[2-[2-methoxy]ethoxy]-acetic acid.

Mono- and polyamines of the general formula Q₃₋ₙNHₙ, where n=0, 1 or 2, whose Q radicals are independent of one another, with C₁-C₁₂-alkyl, especially C₁-C₆-alkyl and more preferably C₁-C₄-alkyl, for example methyl, ethyl, n-propyl and i-propyl and butyl. Additionally aryl, alkaryl or aralkyl having 6 to 24 carbon atoms, for example phenyl, naphthyl, tolyl and benzyl.

Additionally polyalkyleneamines of the general formula Y₂N(—Z—NY)_{y}—Y in which Y is independent of Q or N, where Q is as defined above, y is an integer of 1 to 6, preferably 1 to 3, and Z is an alkylene group having 1 to 4, preferably 2 or 3 carbon atoms. Examples are methylamine, dimethylamine, trimethylamine, ethylamine, aniline, N-methylaniline, diphenylamine, triphenyl-amine, toluidine, ethylenediamine, diethylenetriamine.

Preferred beta-dicarbonyl compounds having 4 to 12, especially 5 to 8 carbon atoms, for example acetyl-acetone, 2,4-hexanedione, 3,5-heptanedione, acetoacetic acid, C₁-C₄-alkyl acetoacetates, such as ethyl aceto-acetate, diacetyl and acetonylacetone.

Amino acids, such as beta-alanine, glycine, valine, aminocaproic acid, leucine and isoleucine.

Silanes which have at least one unhydrolysable group or a hydroxyl group, especially hydrolysable organosilanes which additionally have at least one unhydrolysable radical. Silanes of the general formula RₐSiX₄₋ₐ may preferably serve as the surface-modifying reagent, in which the R radicals are the same or different and represent unhydrolysable groups, the X radicals are the same or different and mean hydrolysable groups or hydroxyl groups, and a has the value of 1, 2, or 3. The value a is preferably 1.

In the general formula, the hydrolysable X groups, which may be the same or different from one another, are, for example, hydrogen or halogen (F, Cl, Br or I), alkoxy (preferably C₁-C₆-alkoxy, for example methoxy, ethoxy, n-propoxy, i-propoxy and butoxy), aryloxy (preferably C₆-C₁₀-aryloxy, for example phenoxy), acyloxy (preferably C₁-C₆-acyloxy, for example acetoxy or propionyloxy), alkylcarbonyl (preferably C₂-C₇-alkyl-carbonyl, for example acetyl), amino, monoalkylamino or dialkylamino having preferably 1 to 12, especially 1 to carbon atoms. Preferred hydrolysable radicals are halogen, alkoxy groups and acyloxy groups. Particularly preferred hydrolysable radicals are C₁-C₄-alkoxy groups, especially methoxy and ethoxy.

The unhydrolysable R radicals, which may be the same or different from one another, may be unhydrolysable R radicals with or without a functional group.

The unhydrolysable R radical without a functional group may, for example, be alkyl (preferably C₁-C₈-alkyl such as methyl, ethyl, n-propyl, isopropyl, n-butyl, sec-butyl and tert-butyl, pentyl, hexyl, octyl or cyclohexyl), alkenyl (preferably C₂-C₆-alkenyl, for example vinyl, 1-propenyl, 2-propenyl and butenyl), alkynyl (preferably C₂-C₆-alkynyl, for example acetylenyl and propargyl), aryl (preferably C₆-C₁₀-aryl, for example phenyl and naphthyl) and corresponding alkaryls and aralkyls (for example tolyl, benzyl and phenethyl). The R and X radicals may optionally have one or more customary substituents, for example halogen or alkoxy. Preference is given to alkyltrialkoxy-silanes.

Examples thereof are CH₃SiCl₃, CH₃Si(OC₂H₅)₃, CH₃Si(OCH₃)₃, C₂H₅SiCl₃ , C₂H₅Si(OC₂H₅)₃, C₂H₅Si(OCH₃)₃, C₃H₇Si(OC₂H₅)₃, (C₂H₅O)₃SiC₃H₆Cl, (CH₃)₂SiCl₂, (CH₃)₂Si(OC₂H₅)₂, (CH₃)₂Si(OH)₂, C₆H₅Si(OCH₃)₃, (C₆H₅Si(OC₂H₅)₃, C₆H₅CH₂CH₂Si(OCH₃)₃, (C₆H₅)₂SiCl₂, (C₆H₅)₂Si(OC₂H₅)₂, (i-C₃H₇)₃SiOH, CH₂═CHSi(OOCCH₃)₃, CH₂═CHSiCl₃, CH₂═CH—Si(OC₂H₅)₃, CH₂═CHSi(OC₂H₅)₃, CH₂═CH—Si(OC₂H₄OCH₃)₃, CH₂═CH—CH₂—Si(OC₂H₅)₃, CH₂═CH—CH₂—Si(OC₂H₅)₃, CH₂═CH—CH₂Si(OOOCH₃)₃, n-C₆H₁₃—CH₂—CH₂—Si(OC₂H₅)₃ and n-C₈H₁₇—CH₂CH₂—Si(OC₂H₅)₃.

The unhydrolysable R radical with a functional group may comprise, for example, as the functional group, an epoxide (for example glycidyl or glycidyloxy), hydroxyl, ether, amino, monoalkylamino, dialkylamino, optionally substituted aniline, amide, carboxyl, acryloyl, acryloyloxy, methacryloyl, methacryloyloxy, mercapto, cyano, alkoxy, isocyanato, aldehyde, alkyl-carbonyl, acid anhydride and phosphoric acid group. These functional groups are bonded to the silicon atom via alkylene, alkenylene or arylene bridging groups which may be interrupted by oxygen or —NH— groups. The bridging groups contain preferably 1 to 18, preferably 1 to 8 and especially 1 to 6 carbon atoms.

The divalent bridging groups mentioned and any substituents present, as in the alkylamino groups, derive, for example, from the abovementioned monovalent alkyl, alkenyl, aryl, alkaryl or aralkyl radicals. Of course, the R radical may also have more than one functional group.

Preferred examples of unhydrolysable R radicals with functional groups are a glycidyl- or a glycidyloxy-(C₁-C₂₀)-alkylene radical, such as beta-glycidyloxy-ethyl, gamma-glycidyloxypropyl, delta-glycidyloxybutyl, epsilon-glycidyloxypentyl, omega-glycidyloxyhexyl and 2-(3,4-epoxycyclohexyl)ethyl, a (meth)acryloyloxy-(C₁-C₆)-alkylene radical, for example (meth)acryloyl-oxymethyl, (meth)acryloyloxyethyl, (meth)acryloyloxy-propyl or (meth)acryloyloxybutyl, and a 3-isocyanato-propyl radical.

Examples of corresponding silanes are gamma-glycidyl-oxypropyltrimethoxysilane (GPTS), gamma-glycidyloxy-propyltriethoxysilane (GPTES), 3-isocyanatopropyltri-ethoxysilane, 3-isocyanatopropyldimethylchlorosilane, 3-aminopropyltrimethoxysilane (APTS), 3-aminopropyltri-ethoxysilane (APTES), N-(2-aminoethyl)-3-aminopropyl-trimethoxysilane, N-[N′-(2′-aminoethyl)-2-aminoethyl]-3-aminopropyltrimethoxysilane, hydroxymethyltriethoxy-silane, 2-[methoxy(polyethylenoxy)propyl]trimethoxy-silane, bis(hydroxyethyl)-3-aminopropyltriethoxysilane, N-hydroxyethyl-N-methylaminopropyltriethoxysilane, 3-(meth)acryloyloxypropyltriethoxysilane and 3-(meth)-acryloyloxypropyltrimethoxysilane.

It is particularly advantageous when the zirconium dioxide powders or zirconium mixed oxide powders present in the inventive dispersion are surface-modified with 3-aminopropyltriethoxysilane (AMEO), ammonium salts of polycarboxylic acids, for example Dolapix CE64 (from Zschimmer & Schwarz), tetraalkyl-ammonium hydroxides, such as tetramethylammonium hydroxide or tetraethylammonium hydroxide.

It is also possible to use mixtures of the aforementioned compounds.

The dispersion can be obtained by
initially charging the inventive zirconium dioxide powder, all at once or in portions, under dispersing conditions at an energy input of less than 200 kJ/m³, in a solvent, preferably water, and optionally introducing one or more surface modifiers and additives for pH regulation,
the amount of powder being selected such that the content of powder is 30 to 75% by weight, and the amount of surface modifier being selected such that the content of surface modifier is 0.1 to 5% by weight, based in each case on the total amount of the predispersion,
the predispersion is divided into at least two substreams, these substreams, in a high-energy mill, are put under a pressure of at least 500 bar, preferably 500 to 1500 bar, more preferably 2000 to 3000 bar, decompressed through a nozzle and allowed to meet one another in a gas- or liquid-filled reaction chamber, thus grinding them.

The process can be conducted such that the dispersion which has already been ground once is circulated and ground by means of the high-energy mill a further 2 to times. It is thus possible to obtain a dispersion with a smaller particle size and/or different distribution, for example monomodal or bimodal.

In addition, the process according to the invention can preferably be conducted such that the pressure in the high-energy mill is 2000 to 3000 bar. With this measure too, it is possible to obtain a dispersion with a smaller particle size and/or different distribution, for example monomodal or bimodal.

It is additionally advantageous to carry out the process according to the invention such that the maximum temperature in the preparation of the (pre)dispersion does not exceed 40° C.

The invention further provides for the use of the inventive zirconium dioxide powder or of the inventive dispersion
for producing ZrO₂ ceramics
as an additive in ceramics; for example, addition to aluminium oxide or silicon carbide can achieve a reinforcement of the material; in the production of PZT ceramics
as a constituent of grinding balls; for example for reinforcing grinding balls based on aluminium oxide
for producing varnishes and coatings, for example in the high-temperature coating of heat exchangers
for fine polishing of glass
as a catalyst and as a catalyst support
in membranes (for example for achieving a high corrosion stability of the membranes)
in ceramic paints and refractory materials
for reinforcing textile fibres, polymer nano-composites, composite materials and adhesive bonds
for establishing a refractive index for optical applications in adhesive systems
as an additive in lighting means and toners.

The present invention allows the preparation of fine zirconium dioxide powders with a high whiteness compared to the prior art. It has been found that, in the preparation of the inventive zirconium dioxide powder via a flame oxidation process, the temperature must not be below a particular wall temperature of the reactor. A person skilled in the art would have attempted to cool the particles very rapidly after they have been generated from the gas phase in order to obtain a fine division typical of the pyrogenic particles. He or she would not have considered an influence of the wall temperature on the whiteness of the zirconium dioxide particles.

### EXAMPLES

Powder

### Example 1

(comparative): 12 kg/h of a solution 1 consisting of 24.70% by weight of zirconium 2-ethyl-hexanoate (as ZrO₂), 39.60% by weight of 2-ethylhexanoic acid, 3.50% by weight of 2-(2-butoxyethoxy)ethanol and 32.20% by weight of white spirit are atomized with 28 m³ (STP)/h of air by means of a nozzle having a diameter of 0.8 mm and mixed with hydrogen (18 m³ (STP)/h and air (225 m³ (STP)/h). The mixture is ignited and the flame is allowed to burn into a reaction chamber surrounded by a casing. The casing is cooled externally to a temperature of approx. 90° C. Subsequently, gases and the solid products are cooled and the zirconium dioxide powder is precipitated in filters.

### Example 2

(comparative): As Example 1, except that the solid products adhering on the casing wall are removed continuously by means of an air cannon.

### Example 3

(according to invention): As Example 1, except that the casing is not cooled externally. The wall temperature is 900° C.

### Example 4

(according to invention): As Example 3.

### Example 5

(according to invention): As Example 3, except using a solution 2 which is obtained by mixing a solution 2a consisting of 25.4% by weight of zirconium 2-ethylhexanoate (as ZrO₂), 39.6% by weight of 2-ethyl-hexanoic acid, 3.5% by weight of 2-(2-butoxyethoxy)-ethanol and 31.5% by weight of white spirit with a solution 2b consisting of 30.7% by weight of Y(NO₃)₃*4H₂O and 69.3% by weight of acetone, where the weight ratio of 2a/2b is 44.57.

Feedstocks and amounts used, and also the BET surface area and the whiteness of the resulting powders, are reproduced in the table.

### Example 6

(comparative): Example 1 from DE102004061698. The zirconium dioxide powder has a BET surface area of 63 m²/g. The Berger whiteness is 84%.

TABLE
Feedstocks and amounts used; BET surface area
and whiteness

| | | Solution | Air for | Air for | | Wall | | |
|---|---|---|---|---|---|---|---|---|
| | Solution I | II | dilution | combustion | H₂ | temp. | BET | Whiteness |
| Example | kg/h | kg/h | m³ (STP)/h | m³ (STP)/h | m³ (STP)/h | ° C. | m²/g | % |
| 1* | 12 | — | 28 | 225 | 18 | 90 | 40 | 84 |
| 2* | 12 | — | 28 | 225 | 18 | n.d. | 39 | 81 |
| 3 | 12 | — | 25 | 220 | 9.5 | 900 | 38 | 93 |
| 4 | 12 | — | 25 | 220 | 9.5 | 900 | 40 | 91 |
| 5 | | 10.5 | 28 | 310 | 15 | 1000 | 38 | 92 |

*Comparative

Dispersion

### Example 7

(according to invention): A mixing vessel is initially charged with 42.14 kg of demineralized water and 1.75 kg of Dolapix CE64 (from Zschimmer and Schwartz), and then, with the aid of the suction nose of the Ystral Conti-TDA 3 (stator slits: 4 mm ring and 1 mm ring, rotor/stator distance approx. 1 mm) under shear conditions, the 43.9 kg of the powder from Example 4 are added. After the intake has ended, the suction nozzle is closed and shearing is continued at 3000 rpm for 10 min.

The predispersion thus obtained has a content of zirconium dioxide powder of 50% by weight. It sediments within one month.

This predispersion is conducted in five passes through a Sugino Ultimaizer HJP-25050 high-energy mill at a pressure of 2500 bar and with diamond nozzles of diameter 0.3 mm. The dispersion thus obtained has a median value of 79 nm and a viscosity at 100 s⁻¹ of 27 mPas. It is stable for at least 6 months with respect to sedimentation, caking and thickening.

1. A zirconium dioxide powder, wherein the powder is present
in a form of aggregated primary particles,
and has a BET surface area of 30 to 150 m²/g and
a Berger whiteness of 88% or more.

2. The zirconium dioxide powder according to claim 1, wherein the zirconium dioxide powder is of pyrogenic nature.

3. The zirconium dioxide powder according to claim 1, wherein the primary particles comprise at least one stabilizing component in a form of an oxide of yttrium, calcium, magnesium or aluminium.

4. The zirconium dioxide powder according to claims 1 to 3 claim 1, wherein the BET surface area is 35 to 65 m²/g.

5. The zirconium dioxide powder according to claim 4, wherein the BET surface area is 37 to 43 m²/g.

6. The zirconium dioxide powder according to claim 1, wherein a sum of proportions of zirconium dioxide and stabilizing component is at least 98% by weight.

7. The zirconium dioxide powder according to claim 1, wherein the powder has a proportion of chloride of less than 0.05% by weight.

8. The zirconium dioxide powder according to claim 1, wherein the powder has a proportion of carbon of less than 0.2% by weight.

9. The zirconium dioxide powder according to claim 1, wherein the powder is a surface-modified zirconium dioxide powder.

10. A process for preparing the zirconium dioxide powder according to claim 1, comprising
atomizing a solution which, as a starting material for the zirconium dioxide, comprises at least one organic zirconium compound and optionally at least one compound which bears the stabilizing component is atomized and
mixing the solution with a combustion gas and air and
burning the mixture in a flame into a reaction chamber surrounded by a casing,
cooling the gases and the solid products and then removing the solid product from the gases,
wherein
a temperature in the reaction chamber and along the side of the wall of the casing facing the reaction chamber is at least 500° C.

11. The process according to claim 10, wherein the temperature at the wall is 700 to 1100° C.

12. The process according to claim 10, wherein the starting material used for the zirconium dioxide is at least one zirconium carboxylate.

13. The process according to claim 10, wherein the starting material is dissolved in an organic solvent.

14. The process according to claim 13, wherein the solvent comprises one or more aliphatic carboxylic acids having 6 to 9 carbon atoms.

15. A dispersion comprising the zirconium dioxide powder according to claim 1 and having a content of zirconium dioxide of 20 to 70% by weight and a mean aggregate diameter determined by means of laser diffraction of less than 200 nm.

16. The dispersion according to claim 15, wherein the dispersion comprises a surface-modified zirconium dioxide powder which is obtained by adding a surface modifier to a liquid phase comprising the zirconium dioxide powder.

17. A ceramic composition comprising the zirconium dioxide powder according to claim 1.
